(19) United States
(12) Patent Application Publication
(10) Pub. No.: US 2007/0222772 A1
(43) Pub. Date: Sep. 27, 2007

(54) System and method for assisting those with diminished mental capacities

(76) Inventor: Melissa Abbott Amick, Dallas, TX (US)

Correspondence Address: J. Kevin Gray, 4731 Wildwood Road, Dallas, TX, 75209, US

(21) Appl. No.: 11/387,824

(22) Filed: Mar. 23, 2006

(51) Int. Cl. G09G 5/00

(52) U.S. Cl. 345/204

(57) ABSTRACT

A system and method is disclosed to associate with a device images corresponding to the control of same for use by those with diminished mental capacities, such as dementia. The system of the present invention associates with a device images corresponding to the control of same with which a person is able to interact with, or control, his or her environment. The images selected and used by the system are user-specific and correspond with visual cues that the individual can recognize and understand. The method of the present invention includes the steps of: (1) identifying a device that a user can manipulate to control or interact with his or her environment; (2) selecting one or more images that the user recognizes as visual cues to correspond with the control mechanism(s) of the device identified in Step (1) above; (3) using the system of the present invention to associate the image(s) selected in Step (2) above with the control mechanism(s) of the device identified in Step (1) above; and (4) repeating, as needed, Steps 1-3 to keep the images of the system matched to visual cues recognized and understood by the user over time.

### CROSS-REFERENCE TO RELATED APPLICATION

This application is a continuation-in-part of, and therefore claims priority from, U.S. Patent Application Ser. No. 60-664,375, filed on Mar. 23, 2005, which is incorporated herein by reference for all purposes.

### TECHNICAL FIELD

The present invention relates to a system and method for assisting those with diminished mental capacities, such as those who suffer with dementia associated with neurodegenerative conditions, Alzheimer's disease and the like, and more particularly to a system and method for image-based control of devices and environment by such individuals.

### BACKGROUND

Dementia is generally defined to be the loss of cognitive function (memory, reason, judgment, and language skills) to an extent where such loss interferes with the daily activities and life of an individual. While not considered a disease by itself, dementia is a collection of symptoms that often accompanies disease, accident or condition. Dementia is often associated with certain brain tumors, depression, metabolic imbalances (e.g., thyroid deficiencies) and even as a natural part of the aging process. It is also seen in association with neurodegenerative conditions such as Parkinson's disease.

Alzheimer's disease (“AD”) is the most common cause of dementia among persons over the age of 65. Over the past few decades, AD has emerged from relative obscurity to a major public health concern. Once considered a rare disorder, it is now known that millions of (primarily older) individuals and their families and caregivers are severely impacted by this disease. It is estimated that approximately 5 million individuals are currently suffering with AD in the United States alone. Additionally, the percentage of people with AD doubles with every 5 year increase in age group beyond the age of 65. Although at present AD is an irreversible, progressive brain-based disease that slowly destroys cognitive and motor skills, there are numerous studies and research efforts that are ongoing in an effort to manage, treat and eventually, prevent it.

The devastating impact of AD on the affected individuals, families, caregivers and even the health care system is hard to overstate. In the United States, as of 2003 there were over 34 million individuals who were 65 years of age or older, or approximately 15% of the entire population. And the so-called “baby boom” will significantly increase this number in the next decade. Moreover, those over 85 years of age—the segment of the population most likely to have AD—are the fastest growing segment of the population. Barring new preventative treatments, researchers estimate that almost 15 million Americans will have AD by 2050.

Aside from the enormous emotional and personal costs associated with treating and caring for those with AD, there is a steadily-rising cost to the already-strained health care system. One recent estimate fixed the current cost of caring for those afflicted with AD at over 100 billion dollars annually. Unfortunately as people live longer they become more likely to suffer from various forms of neurodegenerative disease or dementia, such as AD. Moreover, people suffering with AD are now able to live for much longer periods of time—often for decades—with minimal progression of associated symptoms. Thus improving quality of life of AD patients is becoming an ever greater need.

The manipulation of environment (e.g., objects or devices, such as electronic equipment) by those with diminished mental capacities presents a number of related issues. Once simple tasks like dialing a telephone, turning on or off a lamp or the television, can become overwhelming and confusing, almost Herculean, tasks for those with AD. However, it has been noted that individuals suffering from dementia often respond well to, and otherwise recognize, visual versus language- or text-based cues. Therefore, for example, while it may be difficult to remember the phone number of a relative that has been committed to memory for many years, a dementia sufferer will often still recognize a picture of that relative. Or while it may be impossible to remember that the text “hot” and “cold” designate the two extremes of temperatures on a bathroom faucet, pictures of fire and ice, for example, may still communicate the underlying concept to one with dementia.

There is a need for image-based control of devices and the like, and a method of use of same, to assist those suffering from dementia in interacting with, and controlling, their environments. The need covers both new products, as well as existing ones.

### SUMMARY

The present invention is a system and method for assisting those with diminished mental capacities, such as those who suffer with dementia associated with neurodegenerative conditions, Alzheimer's disease and the like, and more particularly to a system and method for image-based control of devices and environment by such individuals. The present invention takes advantage of the observation that individuals suffering from diminished mental capacities, such as dementia, often respond well to visual cues and instructions when trying to learn new tasks or remember tasks they once knew. This observation holds true even where such individual has lost the ability to associate such tasks with traditional alpha-numerical, text-based controls and/or instructions.

For purposes of this Application, the term “diminished mental capacity” includes those with significant cognitive and/or sensory impairment or deterioration, for example individuals having a medically diagnosed dementia such as Alzheimer's disease or the like, but is also intended to encompass all those capable of being assisted with the present invention. Such individuals could even merely have language barrier issues or other conditions affecting language skills or other cognitive functions. Indeed, the present invention could even assist those that are merely unable to recognize language-based controls/instructions for any reason whatsoever (e.g., those with learning disabilities or infants).

For purposes of this application, the term “device” shall be used to include, without limitation, devices of all kinds and designs, wired or wireless, such as appliances, communication devices (e.g., telephones), audio/visual components (e.g., televisions, DVD payers, radios) computers (of all designs, including personal digital assistants), switches, controls, and the like. As can be appreciated, there is no limit to the electrical, electrical-mechanical, mechanical and other devices that fall within the scope of “device” for purposes of this application.

According to the principles of the present invention, a system is provided to associate with a device one or more images corresponding to the control of same. The images are customized to correspond specifically to images with which a user is able to interact to operate the device or otherwise control his or her environment. For example, in one embodiment of the present invention, images are used to represent a set of numbers, like a telephone number. In this embodiment, a telephone (the device), having a normal set of control buttons, numerical dialing pad and the like, would also include the present invention system, providing images of people the user routinely calls/receives calls from. Using the system, the user could merely touch an image of the person s/he wished to contact and the telephone would be preprogrammed (utilizing the one-touch dialing feature of the telephone) to call the telephone number associated with the individual in the image. Additionally, when that person called the user, the image of the person calling would be highlighted (e.g., a frame around the picture would flash or a bar under the picture would light up, or some similar highlight) to assist the user with recognizing who was calling. Depending upon the complexity of the embodiment of the present invention system, the images could simply be slipped into a sleeve associated with certain buttons (preferably the numerical keys of the phone) on the surface of the phone, or the images could be displayed via a detachable display (e.g., LCD) and could be used in connection with a soft-key or similar system.

In another, more simplistic, embodiment of the present invention, the system is used in connection with a common control mechanism, such as that for water temperature of a faucet in a bathtub and/or shower. In this embodiment, the system would have images associated with the textual-based controls to assist those who are unable to understand/process the text (e.g., HOT or COLD). The images would provide a visual cue as to the meaning of the associated text. So, for example, associated with the text for COLD could be a picture of ice cubes. Similarly, an image of flames could be associated with the text for HOT. Using this embodiment of the system, a user unable to control the temperature of the water based upon recognizing and understanding the text “HOT” and “COLD” could simply use the images provided by the system as a visual cue to accomplish same. Here again in this embodiment, the complexity of the embodiment is wide ranging. The system including the images associated with the text of the temperature control mechanism for the faucet could simply be a water-proof sleeve or the like attached to the wall of the tub/shower into which images could be slipped to have them associated with the text. In addition to the lack of relative expense of this type of embodiment, such an implementation allows for the quick, easy and inexpensive switching out of the images so that the images can be customized for different users and/or changed over time to keep up with the changing level of skills associated with users. Alternatively, this embodiment could be implemented using a relatively sophisticated display system (e.g., LCD), where new and different images could be loaded into the display and displayed in connection with the control mechanism.

It is noted that there exists a substantial body of internationally recognized symbols for common concepts such as temperature, direction, instructions, public activities, and the like that could be utilized in connection with the present invention to give the present invention system immediate utility. And while such internationally-recognized symbols might be particularly useful in the context of use of the present invention for someone with language-barrier issues, it may be wholly inadequate when dealing with another user who is suffering from advanced dementia (since, for example, common symbols may have lost meaning for them, but some other image/symbol continues to convey the underlying concept to that user). The flexibility of the present invention allows both such individuals to be easily accommodated.

In any of the embodiments described herein, an alternative feature of the present invention is the use of audible cues in addition to, or in lieu of, the visual cues described herein. For example, in the telephone example described above, in addition to (or in lieu of) the use of images of those whom the user frequently calls and/or from whom he or she receives calls, the system could also include means for announcing audibly the name of the individual calling/to be called. Therefore, the user would both see the image of the person calling highlighted (e.g., the picture would be backlit or have a bar or frame around it flash or the like) plus a speaker would announce audibly the name of the individual calling/to be called. Since one embodiment of this feature allows for pre-recording the message that is announced in association with placing and/or receiving a call, the short message could also include identifying information with the name (e.g., “Sherry, your daughter, is calling” or “Dialing Dr. Walker, your cardiologist”). Such flexibility in controlling the content of the announced message allows the message to be customized to the specific needs of the user, even as those needs change over time. Therefore, whereas a user may start out only requiring the name of the individual calling be announced, over time identifying information (“your son” or “your cardiologist's office”) could be added to provide further assistance to the user. As previously mentioned, depending upon the embodiment, the audible announcement could be in addition to, or in lieu of, the image-based feature. Moreover, in one embodiment, the audible announcement feature would include an amplification feature, allowing the user to adjust the volume of the audible announcement to match the user's own hearing needs. Therefore, the present invention could assist the visually-impaired by merely announcing the name of the individual calling, for example.

In the telephone example, stock messages can be used with this announcement feature of the present invention to announce standard calls like “UNKNOWN NUMBER,” “NUMBER BLOCKED” and the like. Additionally, known solicitation calls, frequently targeting the elderly and the sick, could be associated with a message that warns the user “DO NOT ANSWER” to assist in avoidance of such calls.

Numerous other examples exist of uses for image- and/or announced message-based devices and the like. For example, control of household appliances, security systems, computers, televisions, radios, stereo equipment, medical equipment, lighting, HVAC, and virtually all electronic or electrical-mechanical control systems via image- and/or announced message-based control is desirable, especially for those with impairments, such as dementia and/or visual impairment.

In general, the principles of the present invention also provide a method for assisting those with diminished mental capacity, such method including the steps of: (1) identifying a device that a user can manipulate to control or interact with his or her environment; (2) selecting one or more images that the user uniquely recognizes as visual cues to correspond with the control mechanism(s) of the device identified in Step (1) above; (3) using the system of the present invention to associate the image(s) selected in Step (2) above with the control mechanism(s) of the device identified in Step (1) above; and (4) repeating, as needed, Steps 1-3 to keep the images of the system matched to visual cues recognized and understood by the user over time. An optional step between Step 2 and Step 3, comprises selecting (e.g., pre-record or select from a stock menu of options) a short message to be announced in connection with control of the device.

The details of one or more embodiments of the invention are set forth in the accompanying drawings and the description below. Other features, objects, and advantages of the invention will be apparent from the description and drawings, and from the claims.

### DESCRIPTION OF DRAWINGS

The FIGURES outlined below further illustrate the system and method of the present invention. Like reference symbols in the various drawings indicate like elements.

FIG. 1 is a front view of a telephone console including an embodiment of the system of the present invention;

FIG. 2 is a front view of a water faucet including an embodiment of the system of the present invention;

FIG. 3 is a front view of a telephone console including another embodiment of the system of the present invention;

FIG. 4 is a front view of a water faucet including another embodiment of the system of the present invention; and

FIG. 5A is a flow chart of steps of one embodiment of the method of the present invention; and

FIG. 5B is a flow chart of steps of another embodiment of the method of the present invention including the optional step of associating a short audible message with, or in lieu of, one or more images to control a device.

### DETAILED DESCRIPTION

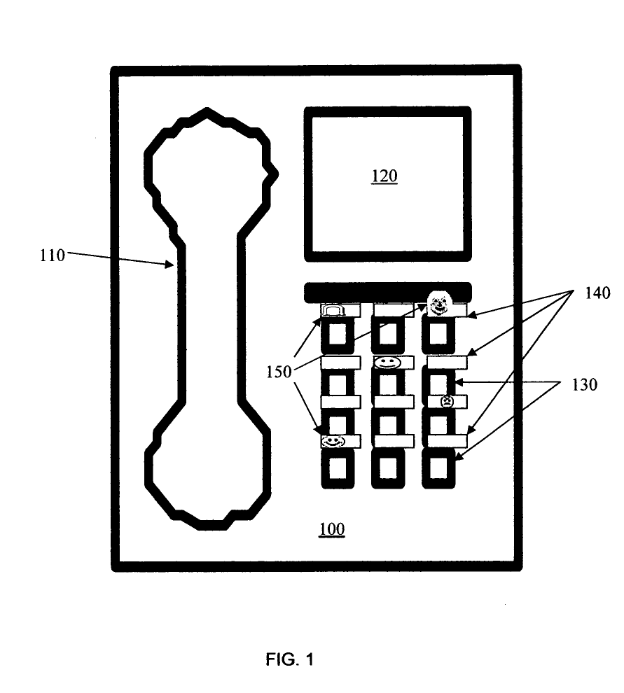

Various embodiments of the principles of the present invention are shown in FIGS. 1-5B and described herein. In general, the principles of the system and method of the present invention provide a system to associate with a device one or more images and, optionally, a short message to be announced, corresponding to the control of the device. The images (and optional short message(s)) are customized to correspond specifically to cues (visual and/or audible) with which a user is able to interact to operate the device or otherwise control his or her environment.

FIG. 1 illustrates a front view of a device, such as a telephone console 100, including an embodiment of the system of the present invention. The telephone console 100 is comprised of typical components, including a handset 110, a screen 120, and buttons 130 for inputting information into the telephone console 100. The present invention system includes control panels 140 associated with certain of the buttons 130. Each of the control panels 140 includes an image 150 of people a user routinely calls/receives calls from. Using the system, the user could merely touch an image 150 of the person s/he wished to contact and the telephone console 100 would be preprogrammed (utilizing, for example, the one-touch dialing feature of the telephone) to call the telephone number associated with the individual in the image 150. Additionally, when that person called the user, the image 150 of the person calling would be highlighted (e.g., a frame around the image 150 would flash or a bar under the image 50 would light up, or some similar highlight) to assist the user with recognizing who was calling. Depending upon the complexity of the embodiment of the present invention system, the images could simply be slipped into a sleeve associated with certain buttons 130 (preferably the numerical keys of the phone) on the surface of the telephone console 100, or the images 150 could be displayed via a display (e.g., the screen 120 or a detachable LCD, or the like) and could be used in connection with a soft-key or similar system.

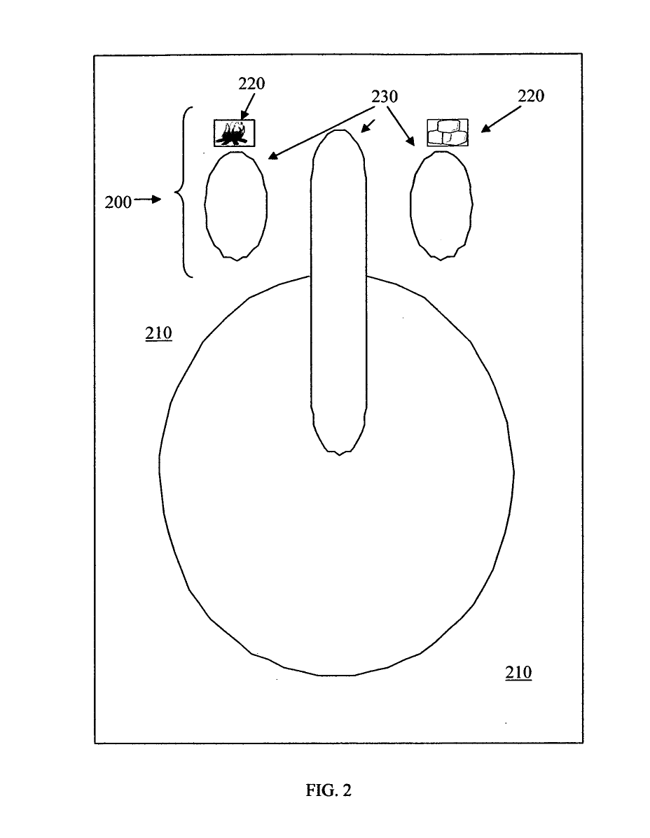

Now turning to FIG. 2, another, more simplistic, embodiment of the present invention, the system is used in connection with a common control mechanism 200, such as that for water temperature of a faucet in a sink 210. The same control mechanism 200 could be used in association with a bathtub and/or shower or the like. In this embodiment, the system would have images 220 associated with the textual-based controls 230 to assist those who are unable to understand/process the text (e.g., HOT or COLD). The images 220 would provide a visual cue as to the meaning of the associated text. So, for example, associated with the text for COLD could be a picture of ice cubes. Similarly, an image of flames could be associated with the text for HOT. Using this embodiment of the system, a user unable to control the temperature of the water based upon recognizing and understanding the text “HOT” and “COLD” could simply use the images 220 provided by the system as a visual cue to accomplish same. Here again in this embodiment, the complexity of the embodiment is wide ranging. The system including the images associated with the text of the temperature control mechanism for the faucet could simply be a water-proof sleeve or the like attached to the sink 210 (or wall of the tub/shower) into which images 220 could be slipped to have them associated with the text. In addition to the lack of relative expense of this type of embodiment, such an implementation allows for the quick, easy and inexpensive switching out of the images 220 so that the images 220 can be customized for different users and/or changed over time to keep up with the changing level of skills associated with users.

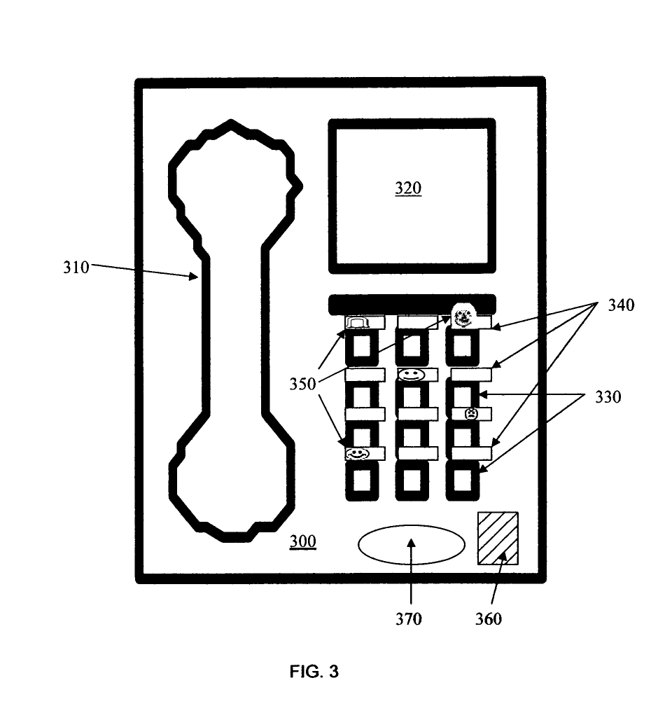

In FIG. 3, again the telephone console 300 is shown employing another embodiment of the system of the present invention. In this embodiment, in addition to (or, alternatively, in lieu of) having control panels 340 and images 350 associated with each of the buttons 330, this embodiment also utilizes a microphone 360 and speaker 370 to provide use of a short audible message to be announced in connection with control of the device (a telephone console 300 in this case). In this embodiment, the user would both see the image 350 of the person calling highlighted (e.g., the image 350 would be backlit or have a bar or frame around it flash or the like) plus the speaker 360 would announce audibly the name of the individual calling/to be called. Since one embodiment of this feature allows for pre-recording the message that is announced in association with placing and/or receiving a call, the short message could also include identifying information with the name (e.g., “Sherry, your daughter, is calling” or “Dialing Dr. Walker, your cardiologist”). Such flexibility in controlling the content of the announced message allows the message to be customized to the specific needs of the user, even as those needs change over time. Therefore, whereas a user may start out only requiring the name of the individual calling be announced, over time identifying information (“your son” or “your cardiologist's office”) could be added to provide further assistance to the user.

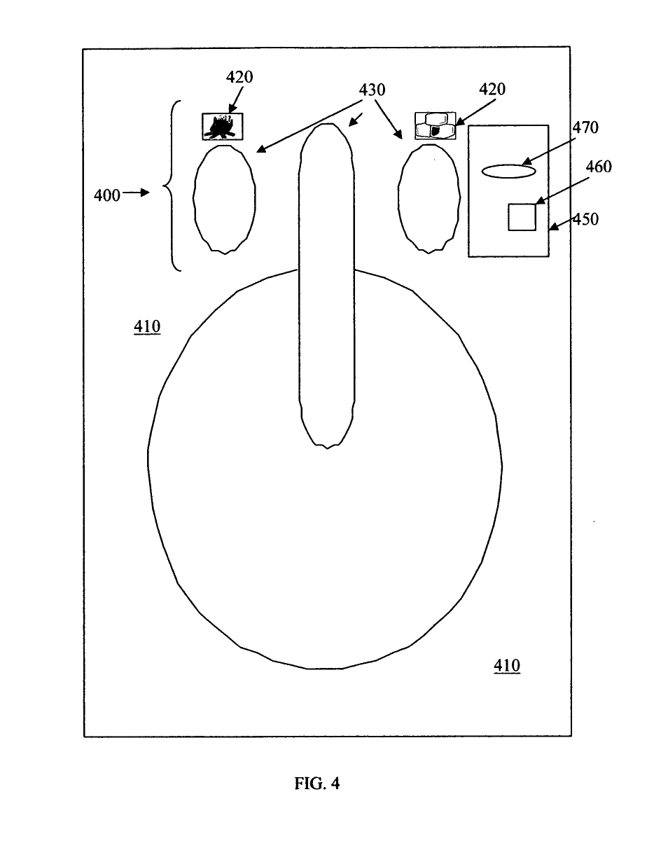

FIG. 4 illustrates a front view of a sink 410 having a control mechanism 400 including another embodiment of the system of the present invention. In this embodiment, a relatively sophisticated display system (e.g., LCD), where new and different images could be loaded into the display and displayed in connection with the control mechanism, is used. In addition to (or, alternatively, in lieu of) having images 420 associated with each of the controls 430, this embodiment also utilizes a detachable unit 450 having an associated microphone 460 and a speaker 470. The microphone 460 and the speaker 470 provide a user the ability to use a short audible message to be announced in connection with control of the device (a sink 410 in this case). In this simplified example, the audible message could be “HOT” or “COLD” (or any other announcement that the user associates with these concepts).

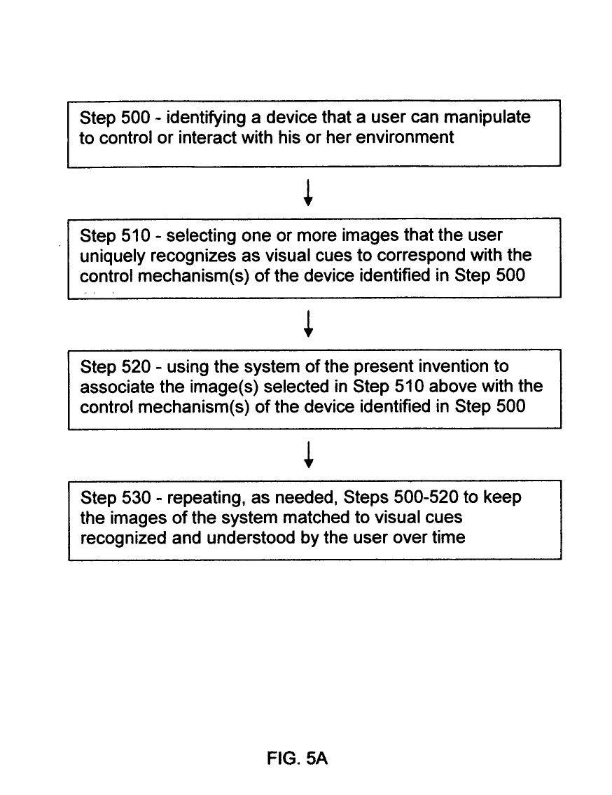

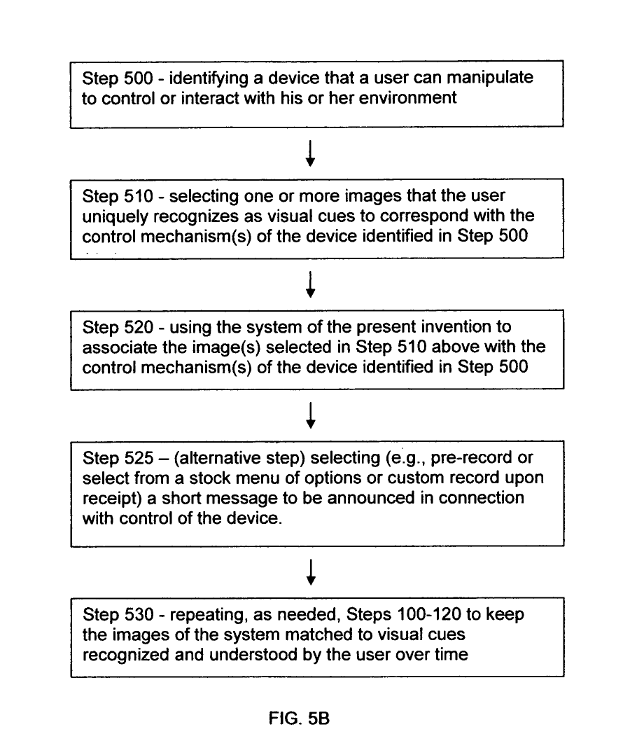

As can be appreciated from the flow chart of FIGS. 5A and 5B, in general, the principles of the present invention also provide a method for assisting those with diminished mental capacity, such method including the steps of: (Step 500) identifying a device that a user can manipulate to control or interact with his or her environment; (Step 510) selecting one or more images that the user uniquely recognizes as visual cues to correspond with the control mechanism(s) of the device identified in Step 500 above; (Step 520) using the system of the present invention to associate the image(s) selected in Step 510 above with the control mechanism(s) of the device identified in Step 500 above; and (Step 530) repeating, as needed, Steps 500-520 to keep the images of the system matched to visual cues recognized and understood by the user over time. As outlined in FIG. 5B, an optional step, Step 525, comprises selecting (e.g., pre-record or select from a stock menu of options or custom record upon receipt) a short message to be announced in connection with control of the device.

Kits including the elements of the present invention system and instructions on employing the present invention method are used to retro-fit existing devices with the present invention. Manufactured-installed systems of the present invention are also contemplated by the instant Application.

A number of embodiments of the invention have been described. Nevertheless, it will be understood that various modifications may be made without departing from the spirit and scope of the invention. Accordingly, other embodiments are within the scope of the following claims.

What is claimed is:

1. A system for image-based control of a device by an individual suffering from dementia, said system comprising:
At least one image display;
said at least one image display capable of removable attachment in close physical proximity to a control mechanism of the device;
said at least one image display capable of selectively displaying images associated with operation of the control mechanism such that the individual can operate the control mechanism based upon the images displayed; and
means for highlighting the at least one image in conjunction with operation of the control mechanism.

2. The system of claim 1, wherein the images displayed uniquely correspond to images recognized and understood by the individual.

3. The system of claim 1, wherein the images displayed are selected from the group consisting of stock images and user-supplied images.

4. The system of claim 1, wherein the at least one image display is a protective sleeve capable of receiving and displaying images.

5. The system of claim 1, wherein the at least one image display is a display selected from the group consisting of: liquid-crystal display; plasma display; cathode ray tube display; and light emitting diode display.

6. The system of claim 1, wherein the images displayed correspond to text- or language-based controls or instructions associated with the control mechanism.

7. The system of claim 1, wherein the means for highlighting the at least one image in conjunction with operation of the control mechanism includes a flashing or otherwise illuminated light.

8. The system of claim 1, wherein the system further includes means for producing a short message along with, or in lieu of, selectively displaying images to assist the individual with operation of the control mechanism.

9. The system of claim 1, wherein the means for producing a short message includes a recording device coupled with a speaker so that unique short messages can be prerecorded for use with the system.

10. The system of claim 9, wherein the means for producing a short message includes means for selecting the short message from a group of stock messages.

11. A kit for image-based control of devices and environment by an individual suffering from dementia, said kit comprising:
means for selecting at least one image to be associated with a control mechanism for a device;
means for selecting a short message to be associated with the control mechanism of the device;
means for associating the selected at least one image and/or the selected short message with the control mechanism of the device; and
means for highlighting the at least one image and/or activating the selected short message so as to aid the individual in controlling the control mechanism of the device.

12. The kit of claim 11, wherein the means for selecting at least one image is a sleeve shaped and sized for removably receiving, containing and protecting the image.

13. The kit of claim 11, wherein the means for selecting at least one image further includes means for selecting the at least one image from a group of stock images.

14. The kit of claim 11, wherein the means for selecting a short message includes means for pre-recording the short message.

15. The kit of claim 11, wherein the means for selecting a short message includes a group of stock messages from which the short message can be selected.

16. A method for image-based control of devices and environment by individuals suffering from dementia, said method comprising the steps of:
(1) identifying a device that a user can manipulate to control or interact with his or her environment;
(2) selecting at least one image that the user recognizes as a visual cue to correspond with control mechanism(s) of the device identified in Step (1) above;
(3) associating the image(s) selected in Step (2) above with the control mechanism(s) of the device identified in Step (1) above; and
(4) repeating, as needed, Steps 1-3 above to maintain the images matched to visual cues recognized and understood by the user over time.

17. The method of claim 16, wherein optional steps following Step 3 and prior to Step 4, comprise:
(3A) selecting a short message to be announced in connection with control of the device; and
(3B) associating the short message selected in Step (3A) above with the control mechanism(s) of the device identified in Step (1) above.

18. The method of claim 17, wherein optional Steps (3A) and (3B) are performed in lieu of Steps (2) and (3).

19. The method of claim 17, wherein the step of selecting a short message to be announced in connection with control of the device (Step (3A)) includes selecting said short message from a set of stock messages.

20. The method of claim 17, wherein the step of selecting a short message to be announced in connection with control of the device (Step (3A)) includes the sub-step of pre-recording the short message.
